(19) United States
(12) Patent Application Publication
(10) Pub. No.: US 2012/0089475 A1
(43) Pub. Date: Apr. 12, 2012

(54) Method and Apparatus for Assessing Residential Customer Pre-Installation Criteria

(76) Inventors: Larry Adair, Chesterfield Twp, MI (US); Candace Dumond, Ruffs Dale, PA (US)

(21) Appl. No.: 12/900,067

(22) Filed: Oct. 7, 2010

(51) Int. Cl. G06Q 30/00

(52) U.S. Cl. 705/26.4

(57) ABSTRACT

A method and apparatus for assessing residential customer pre-installation criteria for installation of an electrical appliance. The method includes providing a user with a variable set of questions and options concerning the location and environment in which the electrical appliance is to be installed. The questions may vary depending on the responses provided by the user. The response provided by the user is interpreted to provide the user with an estimation of the cost, time, and/or feasibility of installing the electrical appliance in a location specified by the user through the responses given to the questions and options.

### FIELD OF THE INVENTION

The present invention relates generally to pre-installation information gathering obviating the need for a site visit by a technician to assess criteria for installation of an item.

### BACKGROUND OF THE INVENTION

Installation of an electric system often requires certain complex work to be executed by a technician with the proper training and experience to correctly and safely install the system. This is essential to reduce the risk of the hazards associated with an electric system. Proper installation can help reduce the chance of injury from electric shock, death by electrocution, or damage to property from an electrical fire. In many locations, electrical systems must meet stringent requirements, such as building codes, and the electrical work may be required to be completed by a qualified person. The installation may require permits, inspection, and approval from a governing body. Another reason for having so many requirements for electrical work is to simply make sure that the system works as intended. The levels of voltage or current that can be provided along any circuit is limited, and improper installation can result in a lack of sufficient power for the number of possible electric connections for electronic items. Also, providing the proper power levels to the correct corresponding electric connection points, or outlets, is important for correct function of the connected electronic items.

Some electronic items, or appliances, require specific connections to be properly installed or used. In some instances the availability of a connection or the possibility of making such a connection is impeded or facilitated by the existing electrical system, or location and environment for the installation. For example, some appliances may be hardwired into the electrical system or require a certain plug, and there may or may not be an existing electrical lead in the area for installation.

Electrical work can potentially be expensive, and each project may require unique approaches. Often a person seeking to install an electrical appliance in a location may desire an estimate for the cost of the work. To provide an estimate for installation, a technician may have to make a site visit to assess the location, the materials and time needed to do the work, and the over all feasibility of the project. From the technician's observations an estimate for the installation project may be provided. For installers, these site visits cost both time and money. It is not in all instances that the site visit is worthwhile for the installer. In some instances, the installation may be routine and not require an expert assessment, other times the installation may not be feasible and the site visit does not result in work for the installer.

Therefore, there is a need for an installer or an appliance supplier to be able to assess the feasibility and cost of an installation project without having to commit the time and money resulting from sending an technician to the installation site.

### SUMMARY OF THE INVENTION

At least in view of the above, it would be desirable to provide a method and apparatus assessing residential customer pre-installation criteria for providing an estimate of cost, time, and/or feasibility of installing an electrical appliance.

The foregoing needs are met, to a great extent, by certain embodiments of the present invention. According to one such embodiment of the present invention, an apparatus for assessing residential customer pre-installation criteria may have a memory for storing a pool of questions and options related to installation of an electric vehicle supply equipment, where the questions and options include questions and options regarding a location for installation in proximity of a residential building, and for storing information indicating responses to selected questions and options. The apparatus may further include a first processor for determining and providing the selected questions and options from the pool of questions and options, retrieving the selected questions and options from the memory, and receiving the information indicating responses to the selected questions and options. Other elements of the apparatus may include a first communication device for connecting to a network for providing the selected questions and options, and receiving the information indicating responses to the selected questions and options.

According to another embodiment of the present invention, a method for assessing residential customer pre-installation criteria may include storing on a memory a pool of questions and options about a location and environment in which an electric vehicle supply equipment is to be installed, where the questions and options include questions and options regarding a location for installation in proximity of a residential building. Other steps may include connecting to a network via a communication device, selecting, via a processor, questions and options from the pool of questions and options, receiving input signals indicating responses to the selected questions and options via the network, storing the input signals indicating responses to the selected questions and options to the memory, determining, via the processor, further questions and options dependent on the input signals indicating responses to the selected questions and options received. The method may also include providing an estimate of a cost of installing the electric vehicle supply equipment in the location and environment based on the received input signals indicating responses to the selected questions and options.

A further embodiment of the present invention, a system for assessing residential customer pre-installation criteria, may include a means for storing configured to store a pool of questions and options related to installation of an electric vehicle supply equipment, where the questions and options include questions and options regarding a location for installation in proximity of a residential building, and further configured to store information indicating responses to selected questions and options. The system may also include a first means for processing configured to determine and provide the selected questions and options from the pool of questions and options, retrieve the selected questions and options from the memory, and receive the information indicating responses to the selected questions and options. Other elements of the system may include a first means for communicating configured to connect to a network for providing the selected questions and options, and receiving the information indicating responses to the selected questions and options.

According to another embodiment of the present invention, an apparatus for assessing residential customer pre-installation criteria may include a memory for storing a pool of questions and options related to installation of an electric vehicle supply equipment, where the questions and options include questions and options regarding a location for installation in proximity of a residential building, and further for storing information indicating responses to selected questions and options. The apparatus may further include a processor for determining and providing the selected questions and options from the pool of questions and options, retrieving the selected questions and options from the memory, and receiving the information indicating responses to the selected questions and options. Other elements may include an input device for receiving commands and transmitting signals representative of the information indicating responses to the selected questions and options to the processor. The apparatus may also have a display in communication with the processor and for displaying a graphical user interface containing the selected questions and options for informing about a location and environment in which the electric vehicle supply equipment is to be installed.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a standalone apparatus for assessing residential customer pre-installation criteria according to an embodiment of the invention.

FIG. 2 is a schematic diagram of a networked system for assessing residential customer pre-installation criteria according to an embodiment of the invention.

FIG. 3 is a flow diagram of a method for assessing residential customer pre-installation criteria according to an embodiment of the invention.

### DETAILED DESCRIPTION

An embodiment of the invention for assessing residential customer pre-installation criteria may provide an apparatus for a user to interact with in order to provide helpful information through an electronic means, such as the internet. That apparatus may be a standalone apparatus, such as a kiosk in a mall or in a store where one might place an order for installation services of an electronic appliance, or a self-checkout station in a store. The service order may be placed as an individual order or in conjunction with the purchase of the appliance. Such a standalone apparatus may be preloaded with the necessary software and data needed to assess the residential customer pre-installation criteria, and the software and data may be updated a variety of ways.

A further embodiment may provide for a system including networked components where one component provides a user interface to provide the information, and another component of the system handles providing the software and/or data to assess the residential customer pre-installation criteria.

In one embodiment of the invention, assessing residential customer pre-installation criteria may include receiving information concerning the location and/or environment, and other criteria useful for determining the feasibility and cost of installing an electronic appliance. The information may be provided by a user, potentially one desiring installation of the electronic appliance in a residence. The user may provide the information via a remote computing device connected to a network, such as a personal computer connected to the internet. The information provided may be in the form of response to questions posed to the user on a website. The user's responses may be transmitted via the network to a local computing device, such as a server. The information received by the local computing device may be used to assess the residential customer pre-installation criteria and provide a feasibility report and/or estimate for the work required to install the electronic appliance.

An example embodiment of the implementation of this invention may be used to assess the installation of electric vehicle supply equipment that can provide level I and/or II charging for electric vehicles. The electric vehicle supply equipment may be required to be hardwired into the electrical system of a residence, or plugged into a certain type of electrical outlet. The information gathered for assessing the installation of the electric vehicle supply equipment may come from a user answering specific questions provided on a website accessed from a home computer and submitted to the website's host, such as the manufacturer or distributor of the electric vehicle supply equipment.

The embodiments of the invention described herein may provide numerous advantages. By forgoing site visits to evaluate the location and environment in which the installation of the electronic appliance is desired, the installer can save both time and money. The gathering of the information from the user provides the installer with data that can help the installation technician prepare materials, permits, and schedule installations more efficiently. Being properly prepared may also reduce the installer's work and time. The installer may be able to provide the user with an estimate for the cost and time of the work faster then conventional site visits.

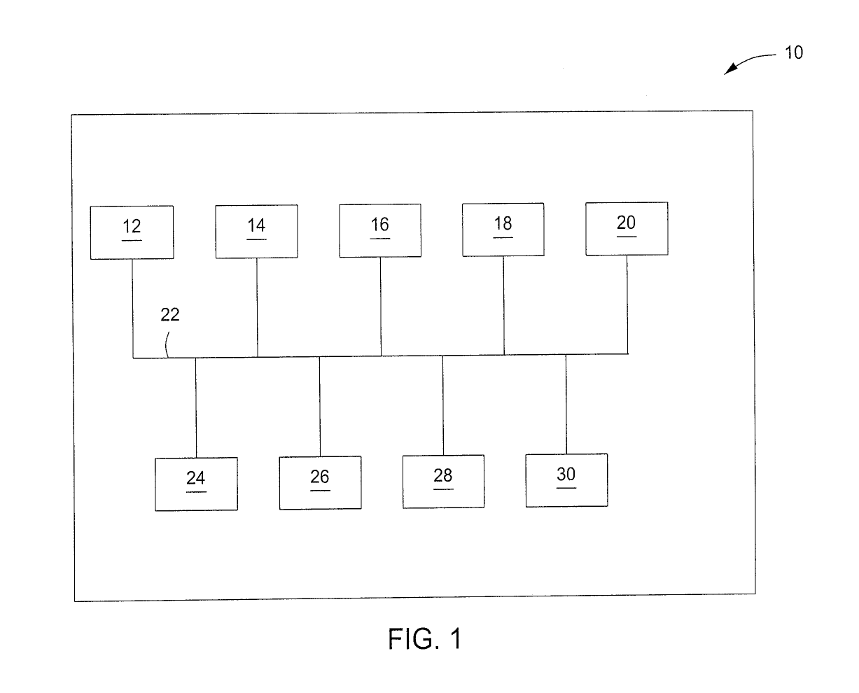

The invention will now be described with reference to the drawing figures, in which like reference numerals refer to like parts throughout. FIG. 1 is a block diagram of a standalone apparatus for assessing residential customer pre-installation criteria according to an embodiment of the invention. One such apparatus may be a remote device 10.

The remote device 10 may include an input device 12, a memory 14, a communication device 16, a processor 18, and a display 20, some or all of which can be interconnected by a data link 22. The remote device 10 may further include a number of modules designed to execute certain functions. Such modules may include a question module 24, a save module 26, an estimate module 28, and a login module 30. In one embodiment, the modules may be software modules in nature. The modules may also be stored on memory 14.

The remote device 10 can be a general computing device, such as a personal computer (PC), a UNIX workstation, a laptop, a server, a mainframe computer, a vehicle diagnostic tool, a personal digital assistant (PDA), a cellular phone, a smartphone, or some combination of these. Alternatively, the remote device 10 can be a specialized computing device made up of components specifically chosen to execute the functionality of the remote device 10, such as a kiosk or specialized handheld devices for use in a store. The remaining components can include programming code, such as source code, object code or executable code, stored on a computer-readable medium that can be loaded into the memory 14 and processed by the processor 18 in order to perform the desired functions of the remote device 10.

The processor 18 may be executed in different ways for different embodiments of the remote device 10. One option is that the processor 18 is a device that can read and process data such as a program instruction stored in the memory 14 or received from an external source. Such a processor 18 may be embodied by a microcontroller. On the other hand, the processor 18 may be a collection of electrical circuitry components built to interpret certain electrical signals and perform certain tasks in response to those signals, or the processor may be an integrated circuit, field programmable gate array (FPGA) or ASIC.

The memory 14 may include, for example, any form or combination of volatile, non-volatile, solid state, magnetic, optical, permanent, removable, writable, rewriteable, and read-only memory. The memory 14 may contain a number of program instructions for use with the remote computer 10. The instructions may include steps, for example, for determining which of a pool of questions or options to present, sometimes dependent on responses to previous questions and options, to determine the criteria of the location and environment in which the electrical appliance unit is to be installed. The electrical appliance unit may be an electric vehicle supply equipment for providing and regulating a connection between an electric or electric hybrid vehicle to a power source for recharging. These steps may include providing an estimate to the party requesting installation of the cost, time, and/or feasibility of the work required. Many other embodiments may provide for further steps, some of which will be discussed herein.

Additionally, an embodiment of the remote device 10 can communicate information to a user through the display 20 and request user input through the input device 12 by way of an interactive, menu-driven, visual display-based user interface, or graphical user interface (GUI). The user may interactively input information using direct manipulation of the GUI. Direct manipulation can include the use of a pointing device, such as a mouse or a stylus, to select from a variety of selectable fields, including selectable menus, drop-down menus, tabs, buttons, bullets, checkboxes, text boxes, and the like. Nevertheless, various embodiments of the invention may incorporate any number of additional functional user interface schemes in place of this interface scheme, with or without the use of a mouse or buttons or keys, including for example, a trackball, a scroll wheel, a touch screen or a voice-activated system.

Some interactions that may be made through GUI via the input device 12 may allow the user control over what responses are provided to a group of questions designed to gather information useful in providing the user with an estimate and or evaluation of the feasibility of installing the electronic appliance. These interactions will be further discussed below.

The display 20 may have various different implementations. Examples of such a display 20 may be any standard or high resolution display. Variety of options are available to implement the display 20, such as, a cathode ray tube screen, a projection screen, a liquid crystal display screen, a plasma screen, or organic light emitting diode screen. The display 20 may be touch sensitive such that the user may interact with the GUI by contact with the display 20. It is also possible that the display 20 is capable of two-dimensional and/or three-dimensional display.

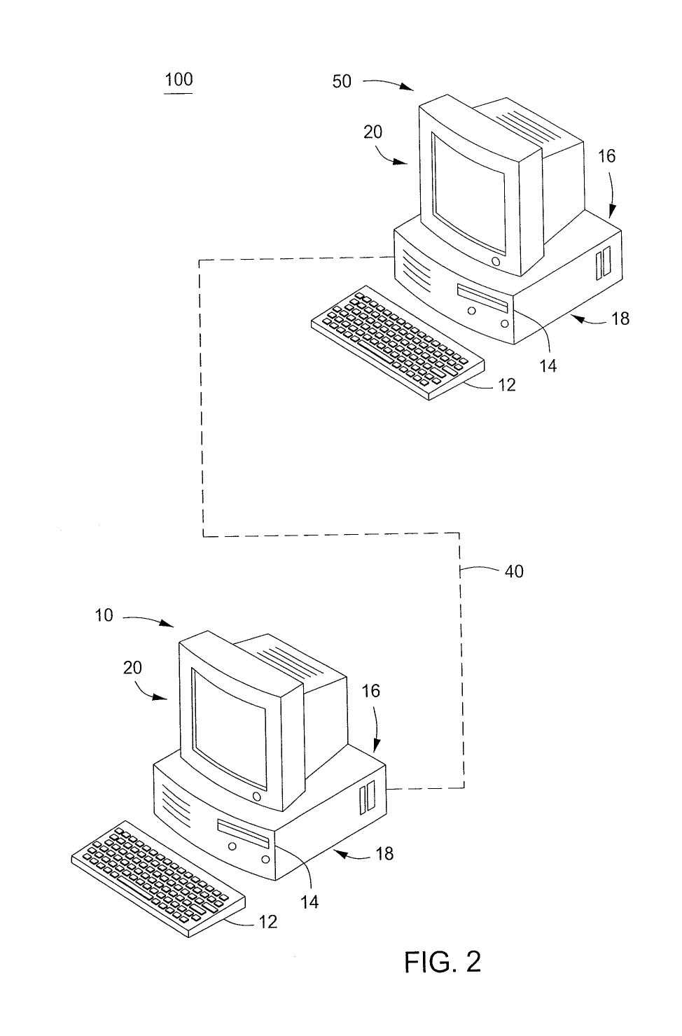

In various embodiments, the remote device 10 can be coupled to a communication network 40 (FIG. 2). The communication network 40 allows for communication between the remote device 10 and other devices. The remote device 10 can be coupled to the communication network 40 by way of the communication device 16 which in various embodiments can incorporate any combination of devices—as well as any associated software or firmware—configured to couple processor-based systems. Such communication devices 16 may include modems, network interface cards, serial buses, parallel buses, LAN or WAN interfaces, wired, wireless or optical interfaces, and the like, along with any associated transmission protocols, as may be desired or required by the design. One use for the communication device 16 is to link to portable media such as a flash drive, CD drive, DVD drive, or any other portable storage media for updating data and software of the remote device 10.

The remote device 10 may further include a number of modules that provide different functionality for the remote device 10. One such module may be the question module 24. The question module 24 determines which questions and options to present to the user to receive the information necessary to be able to provide an accurate estimate to the user requesting the installation. At times, such as at the beginning of the process, the questions may be standard questions presented to each user. In other instances, the questions presented to the user may depend on responses and selections previously made by the user, thus triggering a question or option that is potentially relevant to the location and/or environment for the particular installation that may not be relevant to users who made different responses or selections to the same questions and options. The user may respond to the questions and options via a variety of selectable fields, including selectable menus, drop-down menus, tabs, buttons, bullets, checkboxes, text boxes, and the like. Alternatively, the user can manually input the answer.

Some of the questions, options, or information requested may include the following. Personal information may be requested because it helps identify the person who is requesting the installation and the information can be used to identify and locate the details the user provides about the location and environment. The personal information may include an address, which may be helpful in determining questions based on local options, such as utility companies, or local laws and regulations, such as ones that might require permitting. The location can also help coordinate an installation technician who lives and works nearby to complete the installation work.

The user may be asked to provide information on the user's electric utility service provider. The user may be presented with options of a number of service providers from which the user may make a selection. The options may be tailored based on the user's regional providers, the region may be identified from the user's provided personal information, or from the IP address' location for the user. Rather than selecting from a list of providers, the user may be directed to enter information in text form in a field provided. This information may be used to determine if the user's service provider gives customers rate discounts for using electric or electric hybrid vehicles, or for drawing power at certain time of the day or week. Aside from the specific utility company, other questions about the user's provider, service, or electrical use may be posed. Some examples may include if the user has any type of utility company metering that offers a special rate, central air conditioning, interruptible central air condition service through the local utility service provider, or if the user would be interested in interruptible electric vehicle utility service if available.

Some of the questions may be focused on the structure of the building in which the electric appliance is to be installed. Examples of some such questions include what type or structure of residence the user lives in. An example of a question that may be proffered from the response to this question is if the user indicates that the residence has a basement, then questions concerning whether or not the basement is finished, or the style ceiling the basement has may be posed to the user. If the user does not indicate that the residence has a basement, then basement related questions may never be selected by the question module 24 and thus never presented to the user. The user may be asked if the residence is owned or rented.

Questions such as where the electrical panel is located may be important for the installation of the electrical appliance. Also important may be the type of panel, for example does it use fuses or circuit breakers. Depending on the response to the type of panel, the next question may be tailored specifically to the type of panel indicated. Such a question may inquire as to whether there are unused spaces for connecting to the circuit breakers, or available spaces for adding additional circuit breakers. The manufacturer of the service panel may also be desired information.

On some occasions, the user may be asked to provide information beyond a selection or a written description. The user may be asked to upload a digital file to the system. The files can be of any type, including photo or video files. With respect to the previous service panel information gathering, the user may be asked to upload visual representations of the service panel in different states. For example, a request may be made for a digital photograph of the service panel with the door open, with the door closed, and one of the manufactures label.

A question may be posed to the user concerning the type of parking the user has for the electric or hybrid electric vehicle. The user may be asked if there is a garage at the residence. If so, then more specific questions about the type, location, size, and distance from the residence may be asked. Questions about where the electric or hybrid electric vehicle will be parked within the garage and where the user desires to put the electrical appliance within the garage and how high may also be relevant. Other questions concerning how the garage is finished, for example does it have finished walls and whether the walls are insulated are possible.

The status of the garage's electrical infrastructure is also important, and the existence of electric service sub-panel may be verified. If there is a sub-panel, then similar questions to the ones asked about the main panel, noted above, may be asked. Such questions may include the manufacturer, type, and the space availability. The user may also be asked to provide digital photographs. If there is no sub-panel, then the user may be asked if there is an appropriate outlet, how many of a type of outlet there are, and how the outlet is connected to the main service panel.

If the user does not have a garage, then a description of where the electric or hybrid electric vehicle will be parked may be requested. Also, if the vehicle is to be parked outdoors, the inquiry may be made about whether the electrical appliance will be mounted on a pedestal or if the parking space is covered. There may also be provided a free form text entry for the user to indicate any other comments, such as requesting multiple installations.

The save module 26 may be another module included in the remote device 10. The save module 26 allows for the remote device 10 to save to the memory 14 the user's selections and responses to the questions proffered. The saving of this information allows for a remote user to pull up the information and evaluate it to be able to provide the user with the appropriate estimate. It also allows the user the save the progress made in responding to the questions so that the information is not lost by accident, or so that the user can finish responding at a later time without having to duplicate previous efforts.

An estimate module 28, may be provided in an embodiment of the invention. The estimate module 28, may be capable of analyzing the responses provided by the user, apply values based on generic, average, statistical, or historic information, and generate an automatic estimate of time, cost, and/or feasibility of installing the electrical appliance as requested by the user.

A login module 30 may be an available feature of the invention. The login module 30 in conjunction with the save module 26 may provide a user with a way to partially complete the process of requesting an estimate and returning later to complete it, or later changing some of the response to the questions. The login module 30 may request that the user register a user identification and a security feature, such as a password, so that they may be associated with the user's saved question responses and can be recalled at the user's convenience. When returning to the questions, the user may be prompted by the login module 30 to provide the user identification and security feature to access the save information. The login module 30 will then verify the provided information matches with what is saved in the system and present the user with the questions as previously answered.

The various modules discussed herein may be stored on the remote device 10 or stored on a local device 50 (FIG. 2). If stored on the remote device 10, the communication device 16 may be used to communicate with local device 50 (FIG. 2) to provide the various modules.

Referring now to FIG. 2, a schematic diagram of a networked system for assessing residential customer pre-installation criteria according to an embodiment of the invention is depicted. One such system may be the information system 100. The information system 100 may include the remote device 10, as previously described, and the local device 50.

Much like the previous described remote device 10, the remote device 50, according to an embodiment of the invention, may include the input device 12, the memory 14, the communication device 16, the processor 18, and the display 20, some or all of which can be interconnected by a data link 22 (not shown). The local device 50 may further include a number of modules designed to execute certain functions. Such modules may include a question module 24, a save module 26, an estimate module 28, and a login module 30 as previously discussed. Alternatively, these modules may be stored and accessed remotely similar to an embodiment of the remote device 10.

The input device 12, the memory 14, the communication device 16, the processor 18, and the display 20 may all have similar structural features to the same items previously described. However, in some embodiments, the functions of these items may vary compared to their implementations as part of the remote device 10.

Regarding the input device 12, it may be used in the local device 50 for updating the software and data, stored on the remote device 10 or the local device 50.

The display device 20 may be used by the local device 50 to display activity on the remote device 10 connected to the local device 50. Other uses for the display device 20 on the local device 50 may be to display the GUI and software run locally on the local device 50.

In one embodiment, shown in FIG. 2, there is both the remote device 10 and the local device 50 and the communication network 40 links the communication devices 16 of the remote device 10 and the local device 50 with other devices, and with each other. Various embodiments of the communication network may include any viable combination of devices and systems capable of linking computer-based systems, such as USB; Bluetooth; WiFi; ZigBee; power line communication (PLC); home area network (HAN); Silver Spring network; stable election protocol (SEP); the Internet; TCP/IP; an intranet or extranet; a local area network (LAN); a wide area network (WAN); a direct cable connection; a private network; a public network; an Ethernet-based system; a token ring; a value-added network; a telephony-based system, including, for example, T1 or E1 devices; a cellular telephony system, for example, GPRS or GSM; an Asynchronous Transfer Mode (ATM) network; a wired system; a wireless system; an optical system; a combination of any number of distributed processing networks or systems or the like.

By virtue of the communication network 40 connecting the remote device 10 to the local device 50, information may pass back and forth between the two devices 10, 50. One embodiment may provide for the local device 50 to have the ability to provide the remote device 10 with updated software and data. Further embodiments may allow for some or all of the modules 24, 26, 28, 30 (FIG. 1) to reside on the local device 50. When any of the modules 24, 26, 28, 30 reside on the local device 50, the processes of that module 24, 26, 28, 30 are run as client side processes, as opposed to the server side processes as described above when the modules 24, 26, 28, 30 reside on the remote device 10.

It is contemplated that in different embodiments the remote device 10 and the local device 50 may be interchangeable devices. The two devices 10 and 50 may be capable of storing any information, such as data or code, or executing any task that the other device is capable of as described herein.

Another embodiment may include the remote device 10 providing a downloadable version of the questions for the user. The downloadable version may be downloaded onto the local machine 50, where the user may respond to the questions and upload the information to the remote device 10. The downloadable version may be a file in any number of file formats, for example, .pdf, .doc, .docx, .txt, .xml, .xls, .xlsx, .wpd, .htm, and .html. The files may be saved by the user on the local device 50, after the user has entered responses to the questions, and transmitted back to the remote device 10. The files may include code which allows for the document to behave much like described above, presenting the user with specific questions dependent on the users responses to certain questions presented.

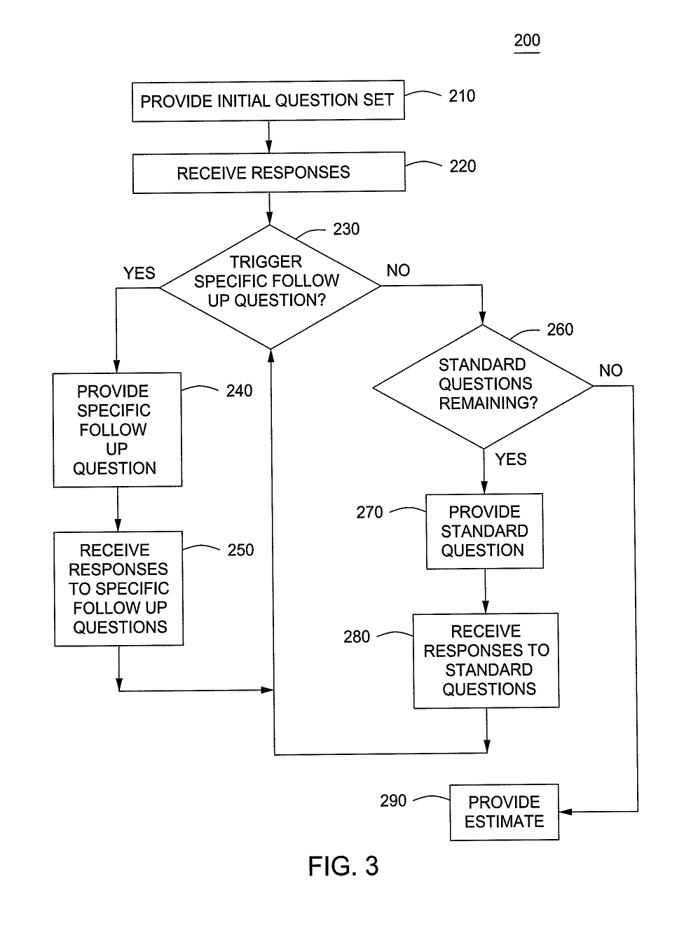

Referring now to FIG. 3, depicted is a flow diagram of a method for assessing residential customer pre-installation criteria 200 according to an embodiment of the invention.

The method for assessing residential customer pre-installation criteria 200 commences when a first set of questions and options are displayed (step 210). The first set of questions may include asking as user for personal information. Following posing the questions and/or options responses are received by the local device 50 or the remote device 10 (step 220). Once received, the responses are analyzed to determine if the responses trigger a specific follow up question (step 230). If a follow up question is triggered, then the specific question and options are displayed (step 240). Once the response to the follow up questions are received (step 250) the system 100 returns to check if a specific follow up is triggered (step 230).

When a specific follow up question is not triggered at step 230, then the system 100 proceeds to determine if there are any remaining standard questions (step 260). If there are remaining, unanswered standard questions, a next set of standard questions is presented (step 270). Once the response to these standard questions is received (280), then the system 100 returns to check if a specific follow up is triggered (step 230).

Once there are not specific follow up questions triggered at step 230, and the system has presented all of the standard questions at step 260, then the system 100 may continue to provide the estimate to the user (step 290). Providing the estimate may be an automated step executed by the estimate module 28, or it may be manual, including a remote user accessing the information, evaluating the information, and providing the estimate, either via the system 100, or via other means, such as postal mail, e-mail, fax, or telephone.

In some embodiments, the user may be requested to provide login information to login to the system 100 and retrieve saved information and either continue responding or change responses to the questions proffered.

In this regard, FIGS. 1, 2, and 3 depict the apparatus, systems, and methods of various embodiments potentially including a general-purpose computer by which the embodiments of the present invention may be implemented. Those of ordinary skill in the art will appreciate that a computer can include many more components than those described herein. However, it is not necessary that all of these generally conventional components be shown in order to disclose an illustrative embodiment for practicing the invention. The general-purpose computer can include a processing unit, and a system memory, which may include random access memory (RAM) and read-only memory (ROM). The computer also may include nonvolatile storage memory, such as a hard disk drive, where additional data can be stored.

An embodiment of the present invention can also include one or more input devices, such as a mouse, keyboard, and the like. A display can be provided for viewing text and graphical data, as well as a user interface to allow a user to request specific operations. Furthermore, an embodiment of the present invention may be connected to one or more remote computers via a communication device. The connection may be over a communication network 40, such as a local area network (LAN) wide area network (WAN), and can include all of the necessary circuitry for such a connection.

Typically, computer program instructions, such as portions of the method for assessing residential customer pre-installation criteria 200, may be loaded onto the computer or other general purpose programmable machine to produce a specialized machine, such that the instructions that execute on the computer or other programmable machine create means for implementing the functions specified in the flowchart. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the flowchart. Further, the steps of the flowchart should not be limited to the order as described and depicted herein. The steps of the flowchart may be arranged in various different arrangements.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the flowchart steps.

Accordingly, steps of the flowchart support combinations of means for performing the specified functions, combinations of steps for performing the specified functions and program instruction means for performing the specified functions. It will also be understood that each step of the flowchart, as well as combinations of steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for assessing residential customer pre-installation criteria, comprising:
a memory configured to store a pool of questions and options related to installation of an electric vehicle supply equipment, wherein the questions and options include questions and options regarding a location for installation in proximity of a residential building, and further configured to store information indicating responses to selected questions and options;
a first processor configured to determine and provide the selected questions and options from the pool of questions and options, retrieve the selected questions and options from the memory, and receive the information indicating responses to the selected questions and options; and
a first communication device configured to connect to a network for providing the selected questions and options, and receiving the information indicating responses to the selected questions and options.

2. The apparatus of claim 1, further comprising:
a remote device with a second processor;
an input device configured to receive commands and transmit signals representative of the information indicating responses to the selected questions and options to the second processor;
a display configured to communicate with the second processor and display a graphical user interface containing the selected questions and options for informing about a location and environment in which the electric vehicle supply equipment is to be installed; and
a second communication device configured to connect to the network for receiving the selected questions and options, and transmitting the information indicating responses to the selected questions and options.

3. The apparatus of claim 2, wherein the remote device is configured to request from the first processor the selected questions and options, the first processor is configured to provide the selected questions and options to the remote device, and the remote device is configured to transmit the information indicating responses to the selected questions and options to the first processor in response to receiving an input signal to transmit.

4. The apparatus of claim 1, wherein the first processor is configured to analyze the information indicating responses to the selected questions and options and select further questions and options dependent on the information indicating responses to the selected questions and options.

5. The apparatus of claim 1, wherein the memory is configured to store identification information associated with the information indicating responses to the selected questions and options for later access.

6. The apparatus of claim 5, wherein the identification information includes a user identifier and a security item.

7. The apparatus of claim 1, wherein the questions and options relate to utility service providers and utility service.

8. The apparatus of claim 1, wherein the questions and options relate to a type of the residential building and electrical connections of the residential building.

9. The apparatus of claim 1, wherein the questions and options relate to a type of vehicle parking area and a layout of the vehicle parking area.

10. A method for assessing residential customer pre-installation criteria, comprising:
storing on a memory a pool of questions and options about a location and environment in which an electric vehicle supply equipment is to be installed, wherein the questions and options include questions and options regarding a location for installation in proximity of a residential building;
connecting to a network via a communication device;
selecting, via a processor, questions and options from the pool of questions and options;
receiving input signals indicating responses to the selected questions and options via the network;
storing the input signals indicating responses to the selected questions and options to the memory;
determining, via the processor, further questions and options dependent on the input signals indicating responses to the selected questions and options received; and
providing an estimate of a cost of installing the electric vehicle supply equipment in the location and environment based on the received input signals indicating responses to the selected questions and options.

11. The method of claim 10, further comprising providing an estimate of a time required to install the electric vehicle supply equipment in the location and environment based on the received input signals indicating responses to the selected questions and options.

12. The method of claim 10, further comprising providing an opinion of a feasibility of installing the electric vehicle supply equipment in the location and environment based on the received input signals indicating responses to the selected questions and options.

13. The method of claim 10, further comprising storing identification information associated with the indicating responses to the selected questions and options.

14. The method of claim 13, further comprising:
receiving input signals indicating identification information via the input device; and
accessing, via the processor, the input signals indicating responses to the selected questions and options associated with the identification information from the memory.

15. The method of claim 10, further comprising:
connecting a remote device and the processor via the network;
notifying the processor that the remote device is ready to receive the selected questions and options;
providing the selected questions and options from the processor to the remote device;
displaying the selected questions and options at the remote device;
receiving the input signals indicating responses to the selected questions and options via an input device of the remote device; and
providing the input signals indicating responses to the selected questions and options to the processor or remote device.

16. The method of claim 15, further comprising:
determining the further questions and options dependent on the input signals indicating responses to the selected questions and options received;
providing the further selected questions and options from the processor to the remote device; and
displaying the further questions and options at the remote device.

17. The method of claim 10, further comprising providing the estimate of at least one of the following: a time, a cost, and a feasibility of installing the electric vehicle supply equipment in the location and environment based on the received input signals indicating responses to the selected questions and options from the remote device to the computing device.

18. The method of claim 10, wherein the questions and options relate to utility service providers and utility service.

19. The method of claim 10, wherein the questions and options relate to a type of the residential building and electrical connections of the residential building.

20. The method of claim 10, wherein the questions and options relate to a type of vehicle parking area and a layout of the vehicle parking area.

21. A system for assessing residential customer pre-installation criteria, comprising:
means for storing configured to store a pool of questions and options related to installation of an electric vehicle supply equipment, wherein the questions and options include questions and options regarding a location for installation in proximity of a residential building, and further configured to store information indicating responses to selected questions and options;
first means for processing configured to determine and provide the selected questions and options from the pool of questions and options, retrieve the selected questions and options from the memory, and receive the information indicating responses to the selected questions and options; and
first means for communicating configured to connect to a network for providing the selected questions and options, and receiving the information indicating responses to the selected questions and options.

22. The apparatus of claim 21, further comprising:
means for computing with second means for processing;
means for inputting configured to receive commands and transmit signals representative of the information indicating responses to the selected questions and options to the second means for processing;
means for displaying configured to communicate with the second means for processing and display a graphical user interface containing the selected questions and options for informing about a location and environment in which the electric vehicle supply equipment is to be installed; and
and second means for communicating configured to connect to the network for receiving the selected questions and options, and transmitting the information indicating responses to the selected questions and options.

23. The system of claim 21, wherein the first means for processing provides an estimate of at least one of the following: a time, a cost, and a feasibility of installing the unit in the location and environment based on the received input signals indicating responses to the selected questions and options.

24. The system of claim 21, wherein the questions and options relate to at least one of the following: utility service providers, utility service, a type of the residential building, electrical connections of the residential building, a type of vehicle parking area and a layout of the vehicle parking area.

25. An apparatus for assessing residential customer pre-installation criteria, comprising:
a memory configured to store a pool of questions and options related to installation of an electric vehicle supply equipment, wherein the questions and options include questions and options regarding a location for installation in proximity of a residential building, and further configured to store information indicating responses to selected questions and options;
a processor configured to determine and provide the selected questions and options from the pool of questions and options, retrieve the selected questions and options from the memory, and receive the information indicating responses to the selected questions and options;
an input device configured to receive commands and transmit signals representative of the information indicating responses to the selected questions and options to the processor; and
a display configured to communicate with the processor and display a graphical user interface containing the selected questions and options for informing about a location and environment in which the electric vehicle supply equipment is to be installed.
